(19) United States
(12) Patent Application Publication
(10) Pub. No.: US 2008/0010688 A1
(43) Pub. Date: Jan. 10, 2008

(54) MEDIA SECURITY FOR IMS SESSIONS

(76) Inventors: Yigang Cai, Naperville, IL (US); Simon Xu Chen, QingDao (CN); Alex Zhi Gang Hu, QingDao (CN); Luke Zhigang Yang, QingDao (CN)

Correspondence Address: DUFT BORNSEN & FISHMAN, LLP, 1526 SPRUCE STREET, SUITE 302, BOULDER, CO, 80302, US

(21) Appl. No.: 11/563,508

(22) Filed: Nov. 27, 2006

(30) Foreign Application Priority Data
Jul. 6, 2006 (CN) 200610103165.7

(51) Int. Cl. H04L 9/32

(52) U.S. Cl. 726/28

(57) ABSTRACT

IMS networks and methods are disclosed for securing media streams for IMS sessions. A CSCF of an IMS network receives a registration message, such as a SIP Register message, from user equipment (UE) of an IMS subscriber indicating whether the UE supports media security. The CSCF then forwards a registration message, such as a Diameter MAR, to a subscriber database that includes a header parameter also indicating that the UE supports media security. A media security system generates media security information (e.g., algorithms, keys, etc), and the subscriber database transmits a response message, such as a Diameter MAA, to the CSCF that includes a header parameter for the media security information. The CSCF transmits a response message, such as a SIP 200 OK message, to the UE that includes a header parameter for the media security information. The UE may use the media security information to secure media streams.

### RELATED APPLICATIONS

This patent application claims priority to a foreign patent application filed in the Chinese Patent Office, having the application number 200610103165.7 and filed on Jul. 6, 2006.

### BACKGROUND OF THE INVENTION

1. Field of the Invention

The invention is related to the field of communications, and in particular, to systems and methods that provide security for media streams being transmitted over an IMS network for an IMS session.

2. Statement of the Problem

As set forth in the 3^{rd} Generation Partnership Project (3GPP), an IP Multimedia Subsystem (IMS) provides a common core network having access-agnostic network architecture for converged networks. Service providers are accepting this architecture in next generation network evolution. The IMS architecture is initially defined by the 3GPP to provide multimedia services to mobile subscribers over an Internet Protocol (IP) network. IP networks have become the most cost savings bearer network to transmit video, voice, and data. IMS uses the advantage of IP networks to provide multimedia services for IMS subscribers on an IMS platform. The signaling used within IMS networks is Session Initiation Protocol (SIP). IMS defines the standard SIP interface between application servers, the IMS core network (CSCF), the IMS subscriber, the IMS database (HSS), and IMS billing elements. These standards can reduce the network integration costs and let the subscriber enjoy more stable services.

On the IMS platform, the traditional supplementary services, such as call forwarding, conferencing, and call waiting are available for IMS subscribers. Also, many new data services, such as instant messaging, video calls, video on wait, and web-based services, will also be available for the IMS subscribers.

One problem with present IMS networks is the security of the data being transmitted over the networks. Because IMS networks are also based on IP networks, the security problems of IP networks translate also to IMS networks. The security of IMS networks should cover both IMS signaling (which is SIP signaling) and the media stream being transmitted over the IMS networks. For IMS SIP signaling security, the 3GPP has already defined standards to specify the rules and procedures. For instance, the 3GPP specification TS 33.203 and TS 33.102 describe an IMS AKA authentication method and IPsec that may be used to authenticate a SIP user and protect (integrity and confidentiality) the SIP signaling messages between the subscriber's user equipment (UE) and the CSCF of the IMS network. The 3GPP specifications can be found at “www.3gpp.org”. Unfortunately, there has not been an efficient and effective method of securing the media stream in IMS networks in addition to the SIP signaling.

### SUMMARY OF THE SOLUTION

The invention solves the above and other related problems with systems and methods that provide security for a media stream being transmitted over an IMS network. To provide the media security, the IMS network provides media security information to user equipment (UE) of an IMS subscriber when the UE registers with the network. The UE may then use the media security information to encrypt, encode, or otherwise protect a media stream being transmitted over the IMS networks to provide end-to-end security of the media stream. Thus, the IMS network as described herein secures the media streams in addition to the signaling messages to provide safe and robust IP media services to its IMS subscribers.

One embodiment of the invention comprises an IMS network comprising a call session control function (CSCF) and a subscriber database. The CSCF receives a registration message from user equipment (UE) of an IMS subscriber. The registration message includes a media security header parameter indicating that the UE supports media security for IMS sessions. The CSCF processes the media security header parameter in the registration message to determine that the UE supports media security. The CSCF then transmits a registration message to the subscriber database. The registration message from the CSCF includes a media security header parameter indicating that the UE supports media security. A media security system associated with the subscriber database processes the media security header parameter in the registration message to determine that the UE supports media security. The media security system then generates media security information responsive to determining that the UE supports media security. For example, the media security information may include one or more media security algorithms and one or more media security keys that are associated with the media security algorithms. The media security algorithms and the associated keys can be used to protect media streams in the IMS network. The subscriber database then transmits a response message to the CSCF. The response message from the subscriber database includes a media security header parameter for the media security information. The CSCF processes the media security header parameter in the response message to identify the media security information. The CSCF generates a response message, and transmits the response message to the UE. The response message from the CSCF includes a media security header parameter for the media security information. The UE may then store the media security information to use for securing media streams.

In another embodiment of the invention, the IMS network is adapted to provide for negotiation between first UE and second UE to determine what media security information to use for an IMS session. To provide the negotiation, the CSCF receives a session initiation message from the first UE to initiate the IMS session with the second UE. The session initiation message includes a session description offer, such as a Session Description Protocol (SDP) offer, from the first UE for the IMS session. The session description offer includes a media attribute for the media security information for the first UE, such as the media security algorithms supported by the first UE. The CSCF then forwards the session initiation message to the second UE. The second UE processes the media security information included in the media attribute of the session description offer, and selects particular media security information to use for the IMS session. For instance, the second UE may select a particular media security algorithm to use for the IMS session. The CSCF then receives a session answer message from the second UE. The session answer message includes a session description answer, such as an SDP answer, from the second UE. The session description answer includes a media attribute for the selected media security information to use for the IMS session. The CSCF then forwards the session answer message to the first UE. The first UE may then process the media attribute in the session answer message to identify the media security information that the second UE selected to use for the session.

In another embodiment, the IMS network is adapted to provide for the secure transmission of a media stream. To transmit a media stream over the IMS network, the first UE may encrypt the media stream according to the selected media security information as described in the preceding paragraph. For instance, if the selected media security information includes a media security algorithm and a media security key, then the first UE encrypts the media stream according to the algorithm and the key. The CSCF then receives the encrypted media stream from the first UE and forwards the encrypted media stream to the second UE. The second UE receives the encrypted media stream from the CSCF, and decrypts the encrypted media stream according to the selected media security information. For instance, if the selected media security information includes a media security algorithm and a media security key, then the second UE decrypts the media stream according to the algorithm and the key.

The invention may include other exemplary embodiments described below.

### DESCRIPTION OF THE DRAWINGS

The same reference number represents the same element on all drawings.

FIG. 1 illustrates an IMS network in an exemplary embodiment of the invention.

FIG. 2 is a flow chart illustrating a method of obtaining media security information during registration in an exemplary embodiment of the invention.

FIG. 3 is a flow chart illustrating a method of negotiating what media security information to use for an IMS session in an exemplary embodiment of the invention.

FIG. 4 is a flow chart illustrating a method of providing a secure transmission of a media stream over an IMS network using the media security information in an exemplary embodiment of the invention.

FIG. 5 illustrates an IMS network in another exemplary embodiment of the invention.

FIG. 6 is a message diagram illustrating the registration of user equipment with an IMS network in an exemplary embodiment of the invention.

FIG. 7 illustrates an example of a SIP Register message in an exemplary embodiment of the invention.

FIG. 8 illustrates an example of a SIP 200 OK message in an exemplary embodiment of the invention.

FIG. 9 is a message diagram illustrating session initiation in an exemplary embodiment of the invention.

FIG. 10 illustrates an example of a SIP Invite message including the SDP offer in an exemplary embodiment of the invention.

FIG. 11 illustrates an example of a SIP 183 Prog message including the SDP answer in an exemplary embodiment of the invention.

### DETAILED DESCRIPTION OF THE INVENTION

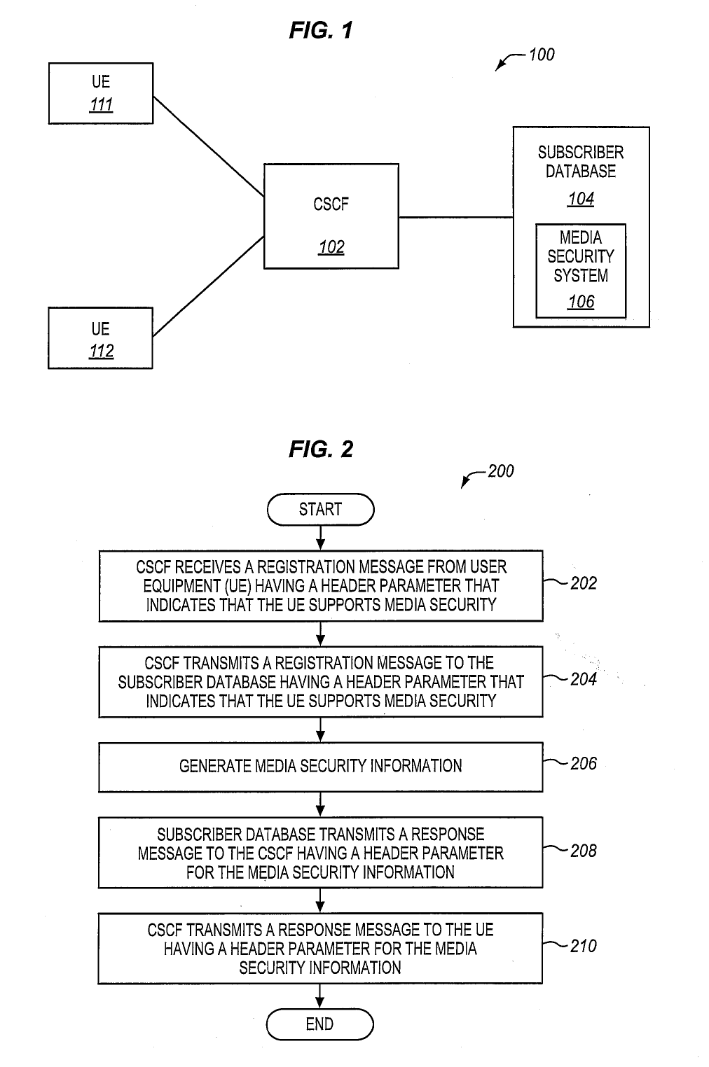

FIGS. 1-11 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an IMS network 100 in an exemplary embodiment of the invention. IMS network 100 includes a Call Session Control Function (CSCF) 102, a subscriber database 104, and a media security system 106. CSCF 102 provides session control in IMS network 100, such as registration of user equipment and session setup/tear down. In this embodiment, CSCF 102 is adapted to provide session control for user equipment (UE) 111 of a first IMS subscriber (not shown) and user equipment (UE) 112 of a second IMS subscriber (not shown). User equipment comprises any wireline or wireless device adapted to communicate with IMS network 100. Subscriber database 104 comprises any database or database system that stores subscriber information or subscriber profiles for subscribers of IMS network 100. One example of subscriber database 104 is a Home Subscriber Server (HSS). Media security system 106 comprises any system, component, software, etc, that generates media security information for session in IMS network 100. Media security system 106 is illustrated as being implemented in subscriber database 104, but media security system 106 may also be remote from subscriber database 104, such as being implemented as a stand-alone system or being implemented in another network node. IMS network 100 may include other networks, systems, or devices not shown in FIG. 1.

According to features and aspects herein, IMS network 100 is adapted to provide media security for media streams transported over IMS network 100. Media security refers to any process or means of protecting or securing media streams in IMS network 100. For instance, if an IMS session is established between UE 111 and UE 112 over IMS network 100, then IMS network 100 is adapted to encode, encrypt, or otherwise protect the media stream exchanged between UE 111 and UE 112. FIGS. 2-4 illustrate an exemplary embodiment of how IMS network 100 provides media security.

For the process of providing media security, IMS network 100 first provides UE 111 with media security information that will be used to encode, encrypt, or otherwise protect the media streams. Media security information comprises any data, encryption algorithms, encryption codes, encryption keys, etc, that may be used to secure media streams. IMS network 100 provides the media security information in this embodiment during the registration process for UE 111, although other methods may be used in other embodiments.

FIG. 2 is a flow chart illustrating a method 200 of obtaining media security information during registration in an exemplary embodiment of the invention. The steps of method 200 will be described with reference to IMS network 100 in FIG. 1. The steps of the flow chart in FIG. 2 are not all inclusive and may include other steps not shown.

In step 202, CSCF 102 receives a registration message from UE 111. The registration message is used by UE 111 to register with IMS network 100, such as a SIP Register message. The registration message from UE 111 may be an initial registration message, such as when UE 111 powers on, or may be a re-registration message periodically transmitted by UE 111. According to features and aspects herein, the registration message includes a media security header parameter indicating that UE 111 supports media security for IMS sessions. A media security header parameter comprises any field or portion of a message header that is designated or used for media security. The media security header parameter of the registration message may include any desired data to indicate that UE 111 supports media security. For instance, the media security header parameter may indicate that UE 111 supports media security by including an indication of one or more media security algorithms supported by UE 111.

CSCF 102 processes the media security header parameter in the registration message to determine that UE 111 supports media security. CSCF 102 then transmits a registration message to subscriber database 104 in step 204. The registration message from CSCF 102 may be used to register UE 111 with subscriber database 104 and to obtain a subscriber profile for UE 111, such as a Diameter Multi-Media Authentication Request (MAR) message. According to features and aspects herein, the registration message from CSCF 102 includes a media security header parameter indicating that UE 111 supports media security. The media security header parameter in the registration message from CSCF 102 may be substantially similar to the media security header parameter in the registration message from UE 111.

Media security system 106, which is associated with subscriber database 104, processes the media security header parameter in the registration message to determine that UE 111 supports media security. If media security system 106 is a remote system, then subscriber database 104 transmits the registration message to media security system 106. If media security system 106 is integrated in subscriber database 104, then media security system 106 can internally access the registration message. Media security system 106 then generates media security information responsive to determining that UE 111 supports media security in step 206. For example, if the registration message from CSCF 102 indicates one or more media security algorithms supported by UE 111, then media security system 106 may generate media security information that includes one or more media security keys that are associated with the media security algorithms.

In step 208, subscriber database 104 (or media security system 106) transmits a response message to CSCF 102. The response message is responsive to the registration message from CSCF 102, such as a Diameter Multi-Media Authentication Answer (MAA) message. According to features and aspects herein, the response message from subscriber database 104 includes a media security header parameter for the media security information generated by media security system 106. The response message may include other information, such as subscriber profile information for UE 111.

CSCF 102 receives the response message from subscriber database 104. CSCF 102 processes the media security header parameter in the response message to identify the media security information. CSCF 102 then generates a response message, and transmits the response message to UE 111 in step 210. The response message from CSCF 102 indicates to UE 111 whether or not UE 111 is registered with IMS network 100. According to features and aspects herein, the response message from CSCF 102 includes a media security header parameter for the media security information. UE 111 then stores the media security information to use for securing media streams. The above signaling messages used for registration may be secured according to techniques described in the 3GPP standards.

If UE 111 initiates an IMS session in IMS network 100, such as an IMS session with UE 112, then UE 111 may use the media security information to protect media streams for the IMS session. When a session is initiated with UE 112, UE 111 negotiates with UE 112 to determine what media security information to use for the session. For instance, UE 111 and UE 112 may negotiate what media security algorithm to use to encrypt the media stream for the session, what media security key to use for the algorithm, etc.

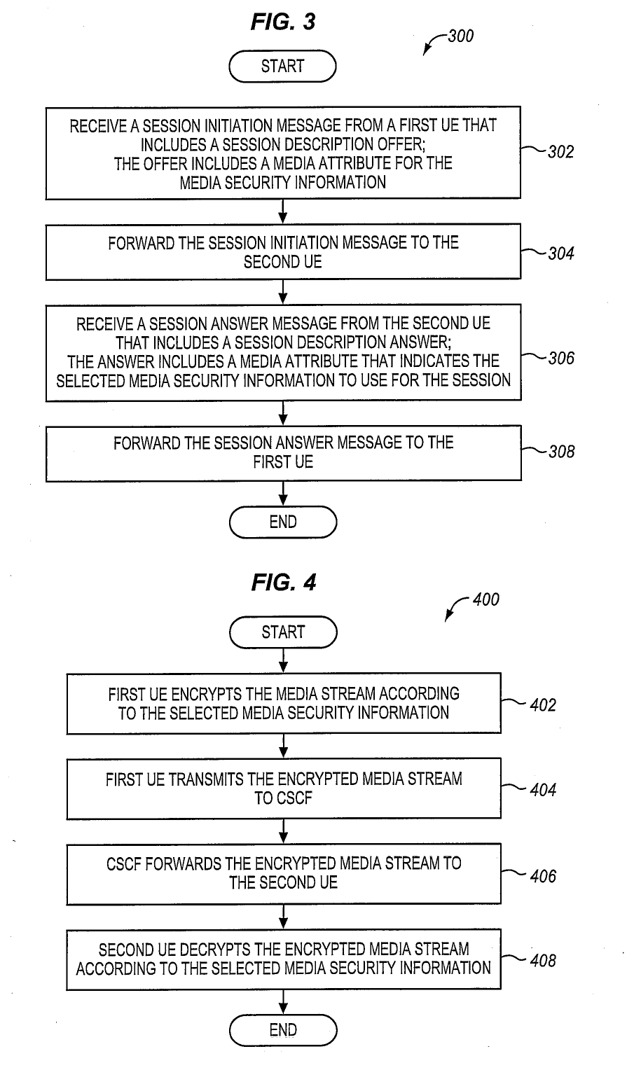

FIG. 3 is a flow chart illustrating a method 300 of negotiating what media security information to use for an IMS session in an exemplary embodiment of the invention. The steps of method 300 will be described with reference to IMS network 100 in FIG. 1. The steps of the flow chart in FIG. 3 are not all inclusive and may include other steps not shown.

In step 302, CSCF 102 receives a session initiation message from UE 111 to initiate an IMS session with UE 112. The session initiation message may comprise a SIP Invite message or another type of message. The session initiation message includes a session description offer, such as a Session Description Protocol (SDP) offer, from UE 111 for the IMS session. The session description offer includes a media attribute for the media security information provided to UE 111 by subscriber database 104. CSCF 102 then forwards the session initiation message to UE 112 in step 304.

Responsive to receiving the session initiation message, UE 112 processes the media security information included in the media attribute of the session description offer. UE 112 selects particular media security information to use for the IMS session. For instance, UE 112 may select a particular media security algorithm to use for encrypting media streams for the IMS session.

In step 306, CSCF 102 receives a session answer message from UE 112. The session answer message may comprise a SIP 183 Prog message, a SIP 200 OK message, or another type of message. The session answer message includes a session description answer, such as an SDP answer, from UE 112. The session description answer includes a media attribute that indicates the selected media security information to use for the IMS session. CSCF 102 then forwards the session answer message to UE 111 in step 308.

Responsive to receiving the session answer message, UE 111 processes the media attribute in the session answer message to identify the media security information that UE 112 selected to use for the session. UE 111 and UE 112 may exchange multiple session description offer/answer messages to negotiate on what media security information to use for the session. UE 111 (or UE 112) may then use the selected media security information to secure or protect a media stream being transmitted over IMS network 100.

FIG. 4 is a flow chart illustrating a method 400 of providing a secure transmission of a media stream over IMS network 100 using the media security information in an exemplary embodiment of the invention. The steps of method 400 will be described with reference to IMS network 100 in FIG. 1. The steps of the flow chart in FIG. 4 are not all inclusive and may include other steps not shown.

To transmit a media stream over IMS network 100, UE 111 encrypts the media stream according to the selected media security information in step 402. For instance, if the selected media security information includes a media security algorithm and a media security key, then UE 111 encrypts the media stream according to the algorithm and the key. UE 111 then transmits the encrypted media stream to CSCF 102 in step 404. CSCF 102 receives the encrypted media stream and forwards the encrypted media stream to UE 112 in step 406.

In step 408, UE 112 receives the encrypted media stream from CSCF 102. UE 112 then decrypts the encrypted media stream according to the selected media security information. For instance, if the selected media security information includes a media security algorithm and a media security key, then UE 112 decrypts the media stream according to the algorithm and the key. Because UE 112 and UE 111 are the only devices in this embodiment that have the selected media security information used to encrypt and decrypt the media stream, end-to-end security of the media stream can thus be achieved between UE 111 and UE 112.

### EXAMPLE

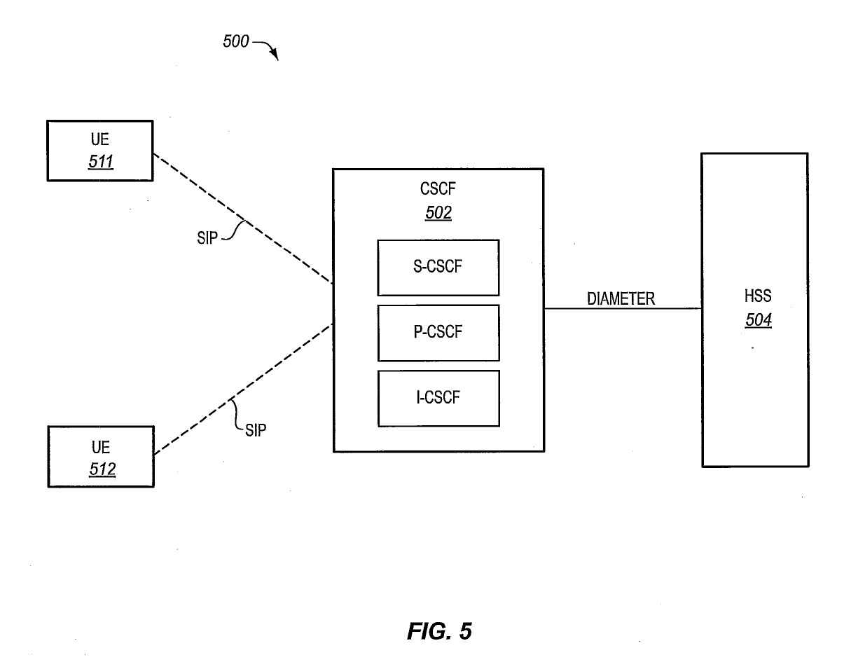

FIG. 5 illustrates an IMS network 500 in an exemplary embodiment of the invention. IMS network 500 includes a Call Session Control Function (CSCF) 502 and a Home Subscriber Server (HSS) 504. CSCF 502 includes a Serving-CSCF (S-CSCF), a Proxy-CSCF (P-CSCF), and an Interrogate-CSCF (I-CSCF). CSCF 502 is the IMS call session control part that handles the IMS SIP messages among user equipment (UE), including the UE registration and call/session setup and tear down. HSS 504 is the home database of the IMS subscribers and keeps their private and service information. CSCF 502 is adapted to communicate with user equipment (UE) 511 of a first subscriber (not shown) and UE 512 of a second subscriber (not shown) using SIP signaling. CSCF 502 is adapted to communicate with HSS 504 using the Diameter interface. IMS network 500 may include other networks, systems, or devices not shown in FIG. 5.

According to features and aspects herein, IMS network 500 is adapted to provide media security for media streams transported across IMS network 500. In this example, UE 511 first obtains encryption keys for one or more encryption algorithms supported by UE 511 during the registration process with IMS network 500. UE 511 then negotiates with UE 512 as to which encryption algorithm to use for an IMS session between UE 511 and UE 512. UE 511 then encrypts media streams with the encryption algorithms selected in the negotiation process. The process is described in more detail as follows.

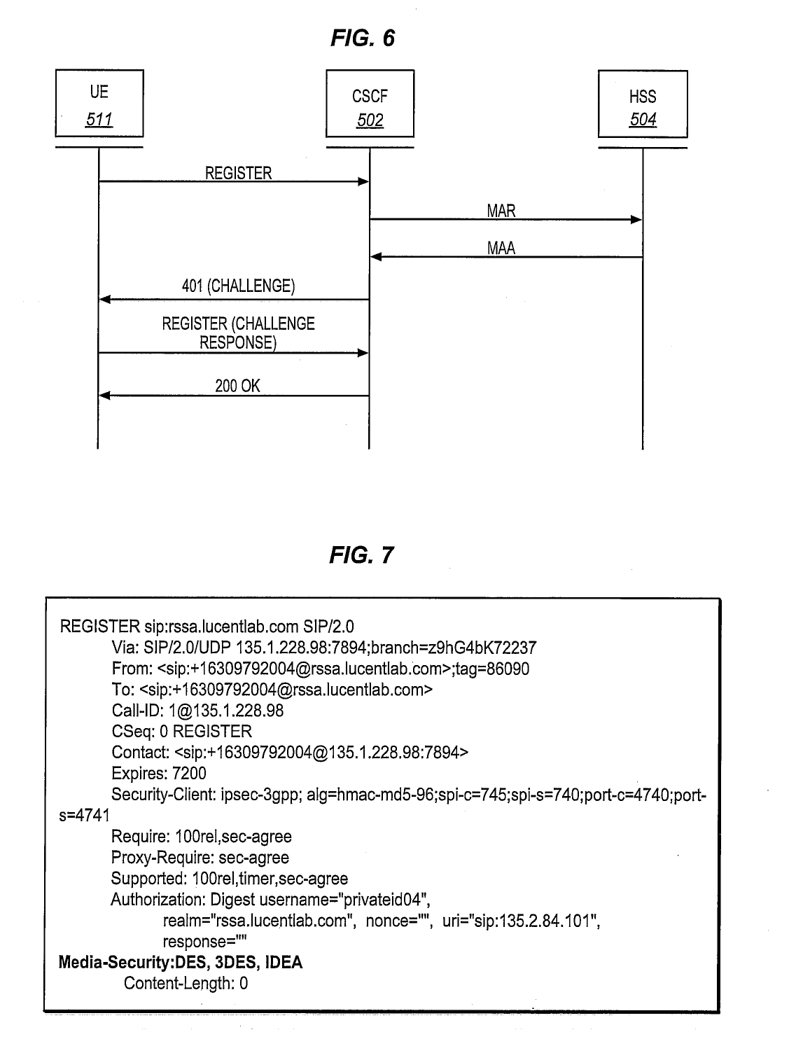

FIG. 6 is a message diagram illustrating the registration of UE 511 with IMS network 500 in an exemplary embodiment of the invention. To start, UE 511 formats a SIP Register message to register with IMS network 500. The Register message could be either an initial Register message or a re-Register message. If UE 511 supports media security and desires to provide media security, then UE 511 enters media security information, which includes encryption algorithms in this example, in a new Media-Security header parameter of the SIP Register message. The format of Media-Security header parameter may be:

Media Security: encryption algorithm 1, encryption algorithm 2, . . .

FIG. 7 illustrates an example of a SIP Register message in an exemplary embodiment of the invention. The Media-Security header parameter of the Register message indicates that UE 511 supports DES, 3DES, and IDEA encryption algorithms and wants to receive the associated encryption keys. When the message is properly formatted, UE 511 transmits the Register message to CSCF 502.

In FIG. 6, CSCF 502 receives the Register message from UE 511 and processes the header of the Register message to identify the Media-Security header parameter. CSCF 502 then formats an associated Diameter MAR message to continue the process of registering UE 511. As part of the formatting, CSCF 502 enters the media security information from the SIP Register message in a new Media-Security header parameter of the MAR message. The value of this header parameter may have the same format as the Media-Security header parameter in the SIP Register message. CSCF 502 then transmits the MAR message to HSS 504.

HSS 504 acts as the subscriber database and the media security system as shown in FIG. 1. HSS 504 processes the MAR message to identify the Media-Security header parameter and the encryption algorithms indicated in the Media-Security header parameter. HSS 504 then generates one or more encryption keys for the encryption algorithms in the Media-Security header parameter. HSS 504 then formats a Diameter MAA message in response to the MAR message. As part of the formatting, HSS 504 enters the encryption algorithms and the associated encryption keys in a new Media-Security-Keys header parameter of the MAA message. HSS 504 then transmits the MAA message to CSCF 502.

CSCF 502 receives the MAA message and saves the encryption algorithms and the associated encryption keys for later use. CSCF 502 transmits a SIP 401 message to UE 511 to challenge UE 511 for an authentication check. UE 511 receives the 401 message, and calculates the authentication response and the security keys used to encrypt SIP messages. UE 511 then formats another SIP Register message and transmits the Register message back to CSCF 502. The Register message is protected by the SIP security keys.

CSCF 502 receives the Register message and determines that the response is valid. CSCF 502 then formats a SIP 200 OK message that is responsive to the initial SIP Register message. As part of formatting, CSCF 502 enters the encryption algorithms and the associated encryption keys from the Media-Security-Keys header parameter of the MAA message into a new Media-Security-Keys header parameter of the 200 OK message. The format of Media-Security-Keys header parameter may be:

Media-Security-Keys: encryption algorithm 1=key value, encryption algorithm 2=key value, . . .

FIG. 8 illustrates an example of a SIP 200 OK message in an exemplary embodiment of the invention. The Media-Security-Keys header parameter of the 200 OK message indicates that the encryption key for the DES encryption algorithm is “1212121212121212”. The Media-Security-Keys header parameter also indicates that the encryption key for the 3DES encryption algorithm is “3434134343434”. The Media-Security-Keys header parameter also indicates that the encryption key for the IDEA encryption algorithm is “8789232323232”.

When the 200 OK message is formatted, CSCF 502 uses the SIP security keys to encrypt the 200 OK message and transmits the secured 200 OK message to UE 511 (see FIG. 6). UE 511 retrieves the Media-Security-Keys header parameter from the 200 OK message and saves the encryption keys associated with the encryption algorithms supported by UE 511. UE 511 can also update the encryption keys anytime using a re-register process.

After UE 511 is successfully registered with IMS network 500 and has received the encryption keys, UE 511 can initiate secure media calls to other UE's that also support the media security. For instance, if UE 511 wants to initiate an IMS session with UE 512, then UE 511 uses SDP offer/answer messages to determine what encryption algorithm to use to secure the media stream.

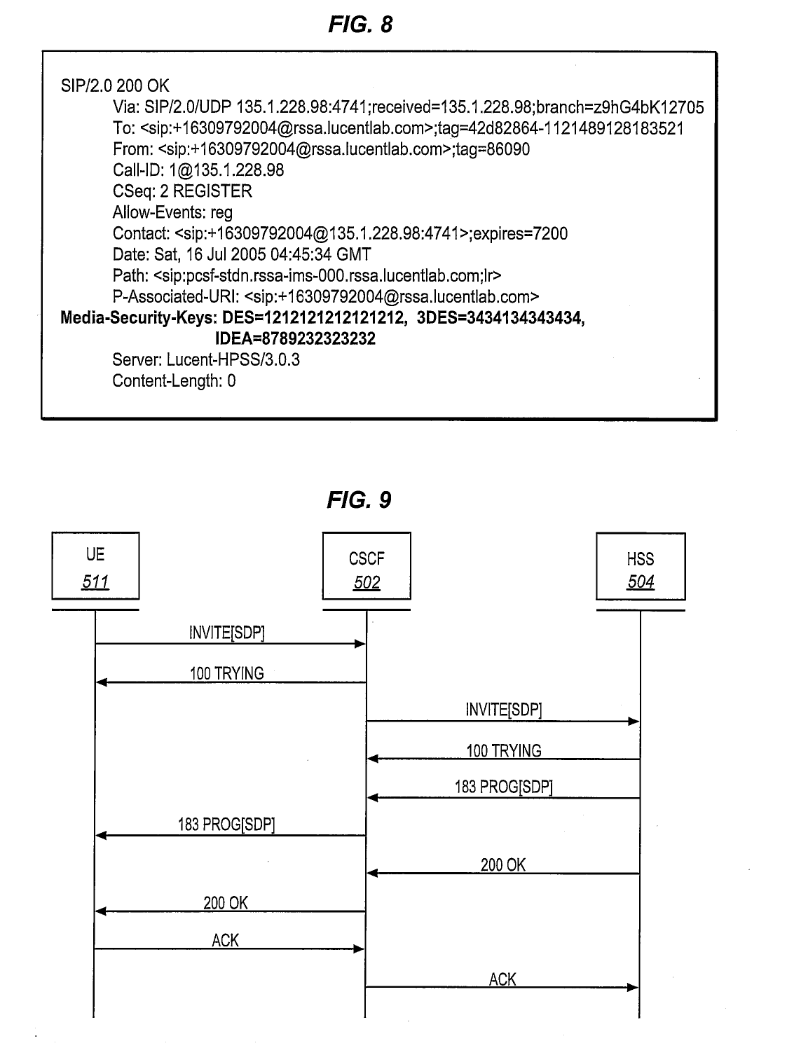

FIG. 9 is a message diagram illustrating session initiation in an exemplary embodiment of the invention. To start, UE 511 formats a SIP Invite message to initiate a secure media session. The SIP Invite message includes a session description, a time description, and a media description that are in Session Description Protocol (SDP). SDP is a textual description of the name and purpose of the session, and the media, protocols, codec formats, time, and transport information for the session. According to features and aspects provided herein, new SDP media attributes are added to the SDP offer. The first SDP media attribute (“Encry_alg” attribute) lists one or more encryption algorithms supported by UE 511 and being offered to UE 512. The second SDP media attribute (“Encry_key” attribute) lists one or more encryption algorithms and the value of its associated encryption key (as previously provided by HSS 504).

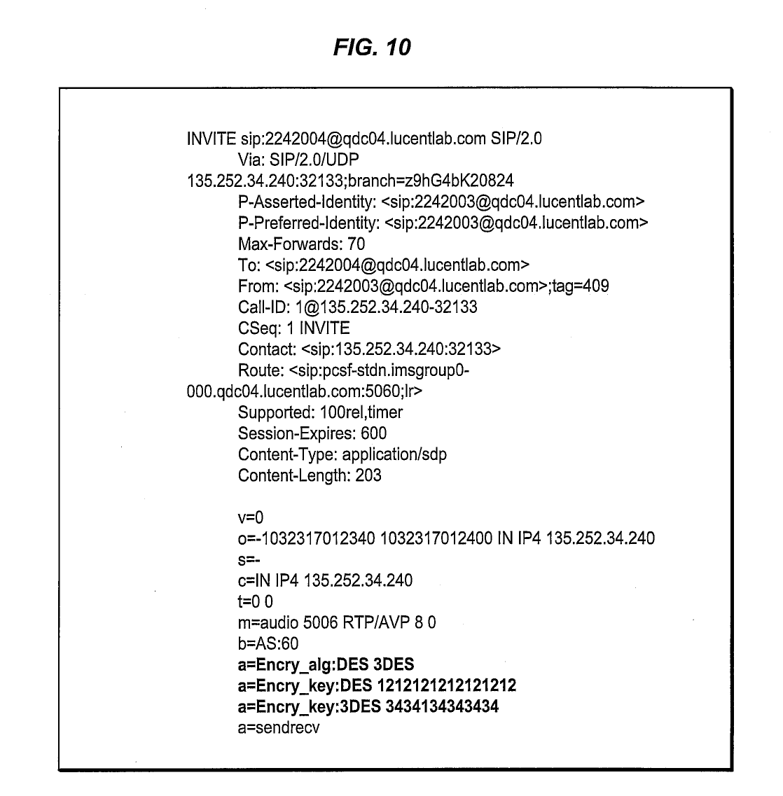

FIG. 10 illustrates an example of a SIP Invite message including the SDP offer in an exemplary embodiment of the invention. The SDP offer includes an “Encry_alg” attribute indicating that UE 511 is offering to use the DES encryption algorithm or the 3DES encryption algorithm. The SDP offer also includes “Encry_key” attributes indicating that the encryption key value for the DES algorithm is “1212121212121212”, and that the encryption key value for the 3DES algorithm is “3434134343434”.

In FIG. 9, UE 511 transmits the SIP Invite message that is received by CSCF 502. CSCF 502 stores the encryption algorithms and keys received from UE 511, and responds to UE 511 with a SIP 100 Trying message. CSCF 502 also forwards the SIP Invite message along with the SDP offer to UE 512.

When UE 512 receives the Invite message from CSCF 502, UE 512 responds with a 100 Trying message. UE 512 processes the SDP offer from the Invite message, and selects a particular encryption algorithm from the SDP offer to use for securing media streams. UE 512 stores the encryption key value for the selected encryption algorithm. UE 512 then formats a SIP 183 Prog message that includes an SDP answer. According to features and aspects provided herein, a new SDP media attribute is added to the SDP answer. The SDP media attribute (“Encry_key” attribute) indicates the selected encryption algorithm and the value of its associated encryption key to use for the IMS session.

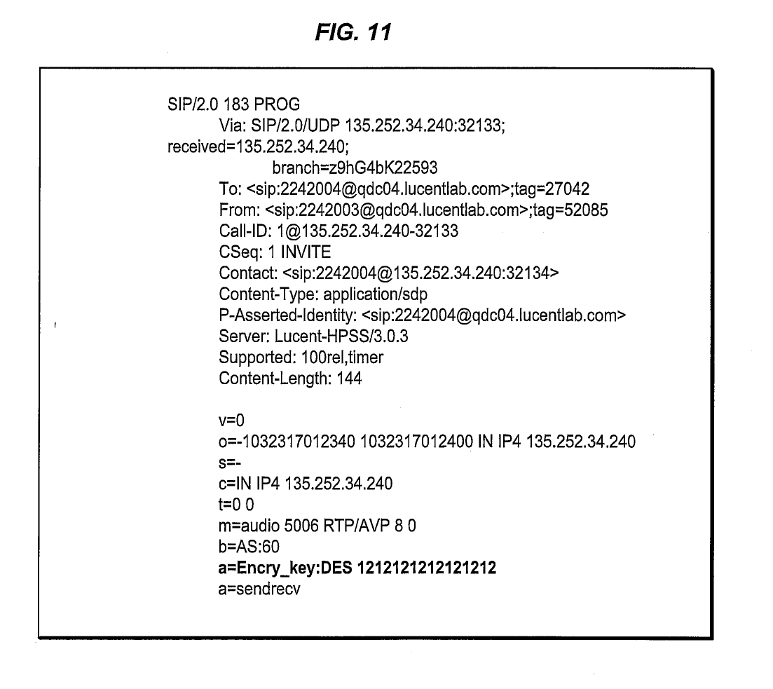

FIG. 11 illustrates an example of a SIP 183 Prog message including the SDP answer in an exemplary embodiment of the invention. The SDP answer includes an “Encry_key” attribute indicating that the selected encryption algorithm is the DES algorithm and the associated encryption key value for the DES algorithm is “1212121212121212”.

In FIG. 9, UE 512 transmits the 183 Prog message that is received by CSCF 502. CSCF 502 stores the “Encry_key” attributes of the 183 Prog message, forwards the message to UE 511. UE 511 processes the SDP answer from the 183 Prog message to identify the selected encryption algorithm to use for securing media streams. UE 511 stores the encryption key value for the selected encryption algorithm. UE 511 and UE 512 may exchange further SDP offers/answers to negotiate as to the type of encryption to use for securing the media streams for the IMS session.

UE 512 then transmits a SIP 200 OK message to CSCF 502 accepting the IMS session with UE 511. CSCF 502 forwards the 200 OK message to UE 511. UE 511 then responds with a SIP ACK message to CSCF 502, where CSCF 502 forwards the ACK message to UE 512. An IMS session between UE 511 and UE 512 is thus established.

A secure IMS session may now be setup using the encryption algorithm and encryption key negotiated in the above steps to protect and encrypt the media stream. To transmit a media stream over IMS network 500 in FIG. 5, UE 511 encrypts the media stream according to the selected encryption algorithm. UE 511 then transmits the encrypted media stream to CSCF 502, in which CSCF 502 forwards the encrypted media stream to UE 512. UE 512 then decrypts the encrypted media stream according to the selected encryption algorithm. Because UE 512 and UE 511 are the only devices in this embodiment that have the selected encryption algorithm and associated encryption key, end-to-end security of the media stream can thus be achieved between UE 511 and UE 512.

This example illustrates an effective and efficient method of providing UE 511 and UE 512 with encryption information to secure media streams. All of the new header parameters introduced herein have been added to existing SIP, SDP, and Diameter messages. Thus, extra message flows are advantageously not needed among the IMS networks to provide the media security.

Although specific embodiments were described herein, the scope of the invention is not limited to those specific embodiments. The scope of the invention is defined by the following claims and any equivalents thereof.

We claim:

1. A method of providing media security in an IMS network, the method comprising:
receiving a first registration message from first user equipment (UE) in a call session control function (CSCF) wherein the first registration message includes a media security header parameter indicating that the first UE supports media security for IMS sessions;
transmitting a second registration message from the CSCF to a subscriber database wherein the second registration message includes a media security header parameter indicating that the first UE supports media security for IMS sessions;
generating media security information based on the second registration message;
transmitting a first response message from the subscriber database to the CSCF wherein the first response message includes a media security header parameter for the media security information; and
transmitting a second response message from the CSCF to the first UE wherein the second response message includes a media security header parameter for the media security information.

2. The method of claim 1 further comprising:
receiving a session initiation message in the CSCF from the first UE to initiate an IMS session with a second UE, wherein the session initiation message includes a session description offer from the first UE for the IMS session, wherein the session description offer includes a media attribute for the media security information; and
forwarding the session initiation message from the CSCF to the second UE.

3. The method of claim 2 further comprising:
receiving a session answer message in the CSCF from the second UE, wherein the session answer message includes a session description answer from the second UE, wherein the session description answer includes a media attribute that indicates selected media security information to use for the IMS session; and
forwarding the session answer message from the CSCF to the first UE.

4. The method of claim 3 further comprising:
encrypting a media stream for the IMS session in the first UE according to the selected media security information;
transmitting the encrypted media stream to the CSCF;
forwarding the encrypted media stream from the CS CF to the second UE;
receiving the encrypted media stream in the second UE from the CSCF; and
decrypting the encrypted media stream according to the selected media security information.

5. The method of claim 4 wherein the selected media security information includes a selected media security algorithm and an associated media security key.

6. The method of claim 1:
wherein the first registration message comprises a SIP Register message; and
wherein the second response message comprises a SIP 200 OK message.

7. The method of claim 1:
wherein the second registration message comprises a Diameter Multi-Media Authentication Request (MAR) message; and
wherein the first response message comprises a Diameter Multi-Media Authentication Answer (MAA) message.

8. The method of claim 3 wherein the session description offer comprises a Session Description Protocol (SDP) offer and the session description answer comprises an SDP answer.

9. An IMS network adapted to provide media security, the IMS network comprising:
a media security system;
a subscriber database; and
a call session control function (CSCF) adapted to receive a first registration message from first user equipment (UE) wherein the first registration message includes a media security header parameter indicating that the first UE supports media security for IMS sessions, and to transmit a second registration message to the subscriber database wherein the second registration message includes a media security header parameter indicating that the first UE supports media security for IMS sessions;
the subscriber database adapted to receive the second registration message;
the media security system adapted to generate media security information responsive to the second registration message;
the subscriber database adapted to transmit a first response message to the CSCF wherein the first response message includes a media security header parameter for the media security information;
the CSCF adapted to receive the first response message, and to transmit a second response message to the first UE wherein the second response message includes a media security header parameter for the media security information.

10. The IMS network of claim 9 wherein the CSCF is further adapted to:
receive a session initiation message from the first UE to initiate an IMS session with a second UE, wherein the session initiation message includes a session description offer from the first UE for the IMS session, wherein the session description offer includes a media attribute for the media security information; and
forward the session initiation message to the second UE.

11. The IMS network of claim 10 wherein the CSCF is further adapted to:
receive a session answer message from the second UE, wherein the session answer message includes a session description answer from the second UE, wherein the session description answer includes a media attribute that indicates selected media security information to use for the IMS session; and
forward the session answer message to the first UE.

12. The IMS network of claim 11 wherein the CSCF is further adapted to:
receive an encrypted media stream for the IMS session from the first UE wherein the media stream is encrypted by the first UE according to the selected media security information; and
forward the encrypted media stream to the second UE that is adapted to decrypt the encrypted media stream according to the selected media security information.

13. The IMS network of claim 12 wherein the selected media security information includes a selected media security algorithm and an associated media security key.

14. The IMS network of claim 9:
wherein the first registration message comprises a SIP register message; and
wherein the second response message comprises a SIP 200 OK message.

15. The IMS network of claim 9:
wherein the second registration message comprises a Diameter Multi-Media Authentication Request (MAR) message; and
wherein the first response message comprises a Diameter Multi-Media Authentication Answer (MAA) message.

16. The IMS network of claim 12 wherein the session description offer comprises a Session Description Protocol (SDP) offer and the session description answer comprises an SDP answer.

17. A method of operating a control function in an IMS network to provide media security for IMS sessions, the method comprising:
receiving a SIP Register message from first user equipment (UE) that includes a media security header parameter indicating at least one media security algorithm supported by the first UE;
transmitting a Diameter Multi-Media Authentication Request (MAR) message to a subscriber database that includes a media security header parameter indicating the at least one media security algorithm;
receiving a Diameter Multi-Media Authentication Answer (MAA) message that includes a media security header parameter indicating at least one media security key associated with the at least one media security algorithm; and
transmitting a SIP 200 OK message to the first UE that includes a media security header parameter indicating the at least one media security key associated with the at least one media security algorithm.

18. The method of claim 17 further comprising:
receiving a SIP session initiation message from the first UE to initiate an IMS session with a second UE, wherein the SIP session initiation message includes a session description protocol (SDP) offer from the first UE for the IMS session, wherein the SDP offer includes a media attribute that indicates the at least one media security algorithm and the associated at least one media security key; and
forwarding the SIP session initiation message to the second UE.

19. The method of claim 18 further comprising:
receiving a SIP session answer message from the second UE, wherein the SIP session answer message includes an SDP answer from the second UE for the IMS session, wherein the SDP answer includes a media attribute that indicates a selected media security algorithm and associated media security key; and
forwarding the SIP session answer message to the first UE.

20. The method of claim 19 further comprising:
receiving a media stream for the IMS session from the first UE, wherein the media stream is encrypted according to the selected media security algorithm and the associated media security key; and
forwarding the media stream to the second UE that is adapted to decrypt the encrypted media stream according to the selected media security algorithm and associated media security key.
